(19) United States
(12) Patent Application Publication
(10) Pub. No.: US 2017/0332843 A1
(43) Pub. Date: Nov. 23, 2017

(54) CHOPPING ACCESSORY, CHOPPING UNIT AND DOMESTIC APPLIANCE FOR CHOPPING

(71) Applicant: KONINKLIJKE PHILIPS N.V, EINDHOVEN (NL)

(72) Inventor: HEIMO OBERSTEINER, EINDHOVEN (NL)

(73) Assignee: KONINKLIJKE PHILIPS N.V, EINDHOVEN (NL)

(21) Appl. No.: 15/523,971

(22) PCT Filed: Nov. 3, 2015
(86) PCT No.: PCT/EP2015/075523

§ 371 Date: May 3, 2017

(30) Foreign Application Priority Data
Nov. 4, 2014 (EP) 14191579.3

(51) Int. Cl. A47J 43/044; A47J 43/046; A47J 43/06; A47J 43/07

(52) U.S. Cl. CPC A47J 43/044; A47J 43/0727; A47J 43/046; A47J 43/06; A47J 43/0711

(57) ABSTRACT

This invention proposes a chopping accessory for chopping food ingredients, comprising: a chopping space having a side wall for containing the food ingredients to be chopped, said side wall having an inner surface facing the chopping space (41); the chopping accessory is arranged to cooperate with a rotatable chopping element (30) for chopping food ingredients in the chopping space during operation, the chopping element comprising at least one rotatable chopping knife (32), the chopping knife having a knife tip (35) at its distal end; and wherein the inner surface of the side wall of the chopping space comprises at least one groove for accommodating the knife tip during operation. By virtue of the proposed solution, the gap between the tip of the chopping knife and the inner surface of the side wall can be eliminated, thereby improving the chopping efficiency of the device.

### FIELD OF THE INVENTION

This invention relates to an improvement on a rotating chopping device for food. Especially, the chopping device is a blender, chopper, cubic cutter or food processor, etc.

### BACKGROUND OF THE INVENTION

When preparing food materials, sometimes vegetables like onions need to be chopped into small pieces, cubes or blocks. If the quantity of ingredients to be chopped is too large , manual chopping always becomes depressing. To reduce the workload of such chopping, usually a blender, chopper or food processor will be used.

The accompanying drawing shown in FIG. 8 is an example of an existing chopping device. A cup-shaped container is used to provide a space for containing ingredients. A chopping knife is arranged on a rotating shaft so as to be at the bottom of the cup. The top end of the shaft could be coupled to a driving mechanism, e.g. a motor. In operation, the motor drives the chopping knife to rotate together with the shaft.

### SUMMARY OF THE INVENTION

However, at a later point in time a problem was discovered in said existing chopping device. Taking into account manufacturing errors and abrasion during operation, there is always a gap 105 arranged between the tips 101 of the chopping knives and the inner surface 103 of the container. This gap 105 adversely affects the chopping efficiency.

Some attempts have been made to increase the efficiency by reducing the size of the gap 105. However, restricted by processing technology limitations, materials and costs, this problem could not be solved perfectly.

This invention aims to solve the above problem by means of the solutions claimed. According to the invention, there is provided a chopping accessory for chopping food ingredients, comprising:
a chopping space having a side wall for containing the food ingredients to be chopped, said side wall having an inner surface facing the chopping space;
the chopping accessory is arranged to cooperate with a rotatable chopping element for chopping food ingredients in the chopping space during operation, the chopping element comprising at least one rotatable chopping knife, the chopping knife having a knife tip at its distal end; and
wherein the inner surface of the side wall of the chopping space comprises at least one groove for accommodating the knife tip during operation.

According to this solution, the groove can receive the tip of the rotating chopping knife, so that the knife tip will not collide with the inner surface of the chopping space. Therefore, the gap between the knife tip and the inner surface of the chopping space can be eliminated. The chopping efficiency can be improved.

Furthermore, the diameter of the outer circumference formed by the rotation of the knife tip is larger than the diameter of the inner surface of the side wall. By virtue of this arrangement, there is an overlap between the knife tip and the inner surface of the chopping space. This can further ensure elimination of the gap in the prior art devices and improve the chopping efficiency.

According to another option, the inner surface of the side wall comprises at least two guidance rims to form the groove therebetween for accommodating the knife tip during operation. In this situation, the diameter of the outer circumference formed by the rotation of the knife tip could be smaller than the diameter of the inner surface of the side wall.

The chopping space could further comprise an opening end and the side wall of the chopping space could further comprise a channel on the inner surface, which channel enables communication between the groove and the opening end of the chopping space. This channel makes assembly and disassembly of the chopping knife easier. Especially when the tip of the chopping knife has a larger diameter than the inner surface of the side wall, the chopping knife can only be assembled in the position corresponding to the groove through the channel.

According to various solutions, the chopping space can be formed directly by a container or by an accessory attachable to a container. In the first situation, the chopping space further comprises a bottom wall, which together with the side wall forms a container for receiving the chopped ingredients. In the second situation, the chopping accessory is attached to a container for receiving the chopped ingredients. During operation, the chopping accessory is arranged on the container and attached to the opening thereof Both aspects should be considered within the scope of this invention.

The chopping accessory can further comprise an outer surface facing away from the chopping space, which comprises at least one rib to reinforce the side wall. As a result, the thickness of the other parts of the chopping accessory can be reduced to save material.

The chopping accessory can have a contoured rim at one end and the container comprises a corresponding contoured rim. When the chopping accessory is attached to the container, the contoured rims are arranged to cooperate with each other to hold the accessory to the container such that the chopping accessory and the container are prevented from rotating with respect to each other during operation.

The chopping accessory can also comprise a chopping protection sieve. During operation, well chopped ingredients having a desired shape or dimension can fall through the holes of the sieve, thus being prevented from “excessive chopping”.

According to another aspect of the invention, there is provided a chopping unit for chopping food ingredients, which comprises:
a chopping accessory as described above; and
a rotatable chopping element for chopping food ingredients in the chopping space during operation, the chopping element comprising at least one rotatable chopping knife, the chopping knife having a knife tip at its distal end.

According to another aspect of the invention, there is provided a domestic appliance for processing food, comprising:
a chopping unit as described above; and
a driving system to drive the chopping element so as to rotate during operation.

The domestic appliance could be any type of rotating food processing device, such as:
a bar blender;
a mixer;
a chopper;
a food processor;
a grinder;
a juicer.

### BRIEF DESCRIPTION OF THE DRAWINGS

Examples of the invention will now be described in detail with reference to the accompanying drawings, in which:

FIG. 1 shows an embodiment of a hand blender according to the invention in an exploded view, wherein the power unit is omitted;

FIG. 2 shows assembled parts of the hand blender of FIG. 1 in a cross sectional view, with the cover removed;

FIG. 3 shows a chopping accessory of the type used for the hand blender in FIG. 1 in a perspective view;

FIG. 4 shows the protection accessory of FIG. 3 in a top view;

FIG. 5 shows the protection accessory of FIG. 3 in a side view;

FIG. 6 shows parts of the hand blender in a top view, wherein the chopping element is in an assembled or disassembled state;

FIG. 7 shows parts of the hand blender of FIG. 6, wherein the chopping element is in an operation position;

FIG. 8 shows an example of the chopping accessory used for the existing chopping apparatus.

### DETAILED DESCRIPTION OF THE EMBODIMENTS

Details of the preferred embodiments will now be described with reference to the drawings, which show the invention applied to a hand blender.

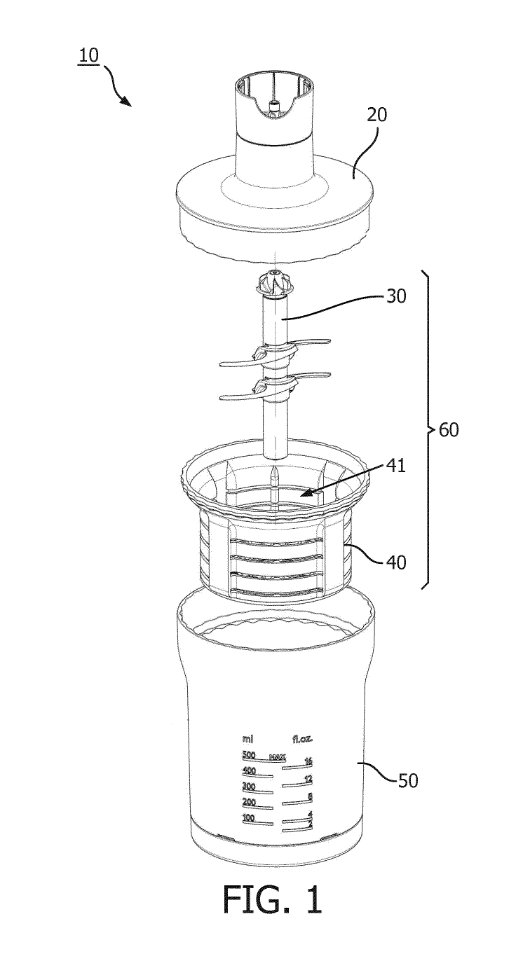

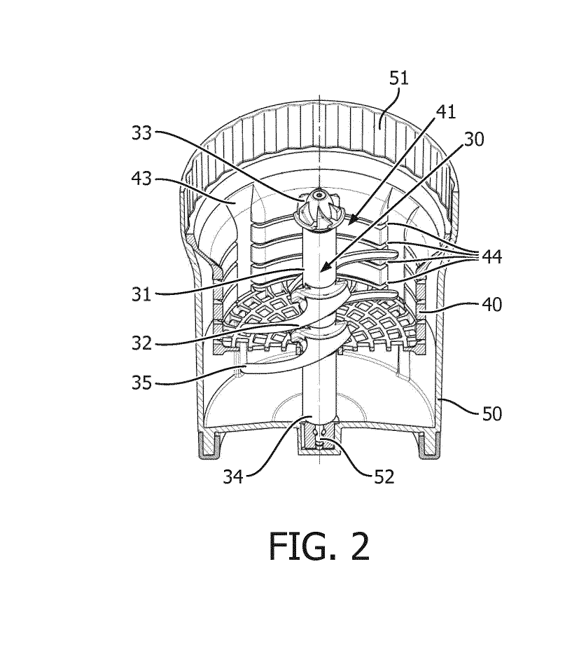

FIG. 1 shows an example of a hand blender 10 according to this invention, in an exploded view, wherein the power unit is omitted. FIG. 2 shows parts of the hand blender of FIG. 1 in a cross sectional view, wherein the cover is removed. The hand blender 10 comprises a chopping accessory 40, a container 50, a chopping element 30, a cover 20 and a power unit (not shown), wherein the chopping accessory 40 and the chopping element 30 form a chopping unit 60.

The container 50 is used to contain the well chopped materials. Generally, it is cup-shaped, with scale divisions on the side wall to indicate the volume or quantity of the chopped materials. At the centre of the bottom of the container, a pin 52 is arranged for locating and bearing the chopping element 30 after assembly. The upper part of the container 50 has a larger diameter than the lower part, to form a sitting surface in the transition area for the chopping accessory 40 to sit on. However, it can be envisaged that the container could have a uniform diameter in the vertical direction in other embodiments. The chopping accessory 40 is then positioned using other methods.

The chopping accessory 40 is also cup-shaped, which both restricts and forms the chopping space 41 therein. In other embodiments (not shown), the chopping accessory 40 could also be cage-shaped without a bottom. During operation, for example, the cage is placed on a plate or the chopping knives rotate along the horizontal direction.

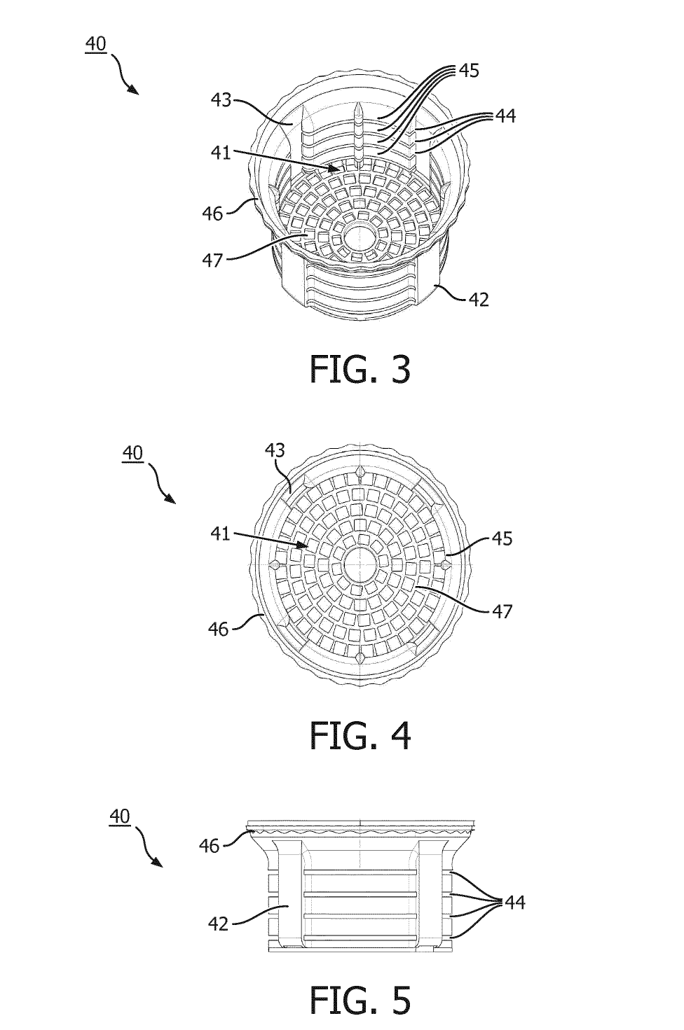

After assembly, the chopping accessory 40 is positioned coaxially with the container 50. As shown in FIGS. 3-5, its top part also has a larger diameter, enabling the chopping accessory 40 to sit on the sitting surface of the container 50. In addition, the chopping accessory 40 comprises a contoured rim 46, which could cooperate with the corresponding contoured surface 51 of the top part of the inner surface of the container 50. As a result, the chopping accessory 40 can be fixed relative to the container 50, preventing relative rotation during operation.

A chopping element 30 is used to chop the ingredients within the chopping space 41, which comprises a central shaft 31 and four layers of rotating chopping knives 32. Its bottom end 34 sits on the pin 52 and its top end 33 could be coupled to the power unit through the cover 20.

At the bottom, the chopping accessory 40 comprises a chopping protection sieve 47. During operation, the well chopped materials having a desired shape or dimension will fall through the holes of the protection sieve 47. This ensures that the ingredients will not be “excessively chopped”.

On its inside surface, four horizontal ring-shaped grooves 44 are arranged in parallel in the vertical direction. For receiving the tips 35 of the chopping knives 32, the vertical positions of these grooves 44 correspond to the chopping knives 32 of the chopping element 30 after assembly.

The diameters of the outer circumference formed by the rotation of the knife tips 35 are larger than the diameter of the inner side wall of the chopping accessory 40. As a result, without the horizontal grooves 44, the chopping knives 32 cannot rotate within the chopping accessory 40. The width and depth of these grooves 44 and the size of the chopping knives 32 are specially designed. In one aspect, the chopping knife 32, in operation, can freely rotate without colliding with the groove 44. In another aspect, an overlap is formed between the knife tips 35 and the inner side wall of the chopping accessory 40, which can further eliminate the gap known in the prior art. Therefore, it is possible for the chopping knives to wipe the ingredients sticking to the inside surface during operation. In addition, said overlap can build up cutting edges 50 which can make the chopping process more efficient. In some other embodiments, the overlap mentioned above can also be formed by two rims on the inner surface.

It can be easily envisaged that, in other embodiments, the hand blender can work without such an accessory. In these embodiments, the grooves for receiving the knife tips are arranged directly on the inner side wall of the container. The diameter of the outer circumference formed by the rotation of the knife tips could be larger than the diameter of the inner side wall of the container. The overlap can still be formed and the gap can also be eliminated.

Furthermore, in the figures, four grooves 44 are shown and there are four layers of chopping knives 32. However, based on customer requirements, other chopping elements with two or three layers of chopping knives can be used to replace the current chopping element 30.

On the inner side wall of the chopping accessory 40, there are also four channels 43 arranged in parallel but perpendicularly to the grooves 44. These channels 43 are used as the paths for knife tips 35 to pass during the assembly of the chopping element 30. Therefore, they enable communication between the grooves 44 and the opening end of the chopping accessory 40. In the accompanying drawings, the channels 43 are substantially perpendicular to the grooves 44, but those skilled in the art know that this is not mandatory.

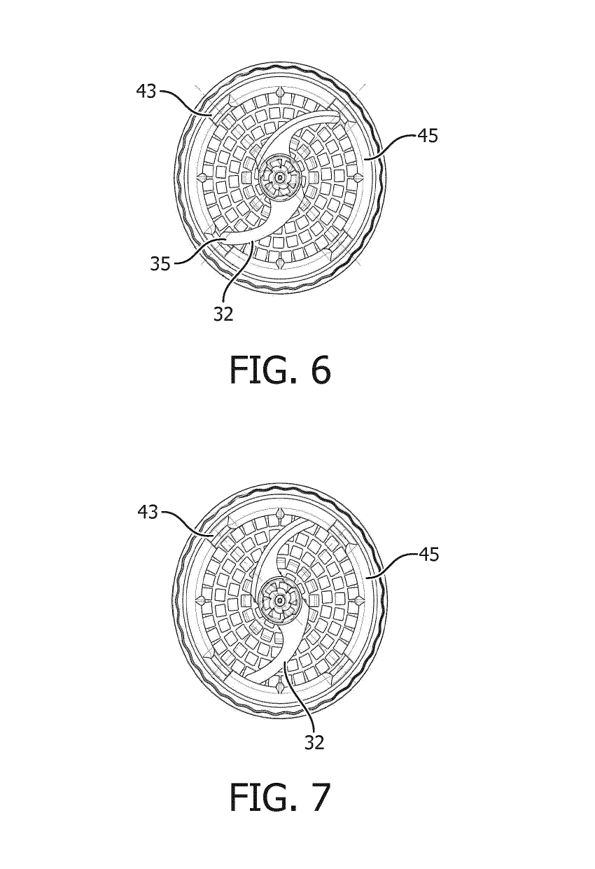

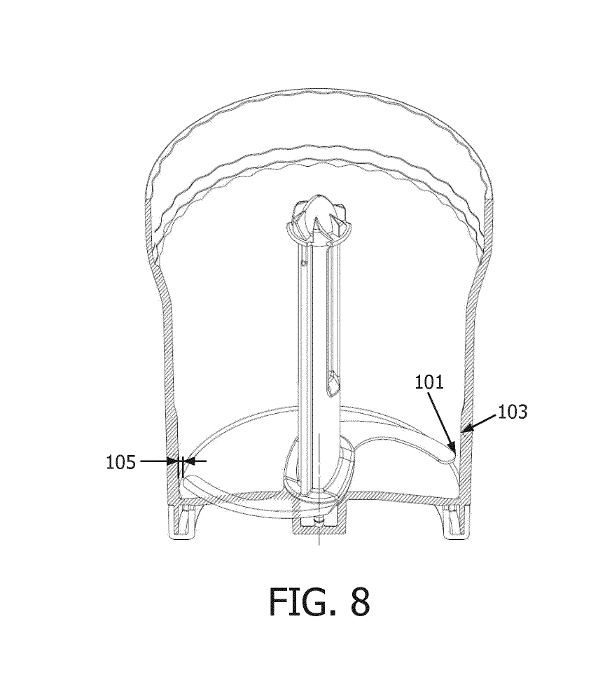

From the top view shown in FIGS. 6 and 7, the overlap mentioned above and the channels 43 can be observed clearly. FIG. 6 shows the chopping element 30 in assembled or disassembled state. It can be seen that the knife tips 35 are in the channels 43. However, in FIG. 7, during the operation, the knife tips 35 are blocked by the cutting edges 45.

As shown in FIG. 5, on the outside surface of the chopping accessory 40, several ribs 42 can be arranged for reinforcement. By virtue of these ribs 42, the thickness of the other parts of the chopping accessory 40 can be smaller. In the embodiment shown, the grooves 44 even penetrate the side wall of the chopping accessory 40.

Before operation of the device is initiated, the container 50, the chopping accessory 40, the chopping element 30 and the cover 20 are assembled. The chopping accessory 40 is placed into the container 50. The contoured rim 46 fits into the contoured surface 51, which can provide a fixation against rotation. Then, the chopping element 30 is inserted into the chopping accessory 40, with the knife tips 35 passing vertically through the channels 43. The ingredients to be chopped are introduced into the chopping space 41 of the chopping accessory 40 and then the cover 20 is put on top to close the container 50. Finally, the driving unit (powered or manual) is assembled onto the cover 20 and its driving shaft is coupled to the top end 33 of the chopping element 30.

During operation, the knife tips 35 rotate in the grooves 44. Because of the overlap, the ingredients can be chopped more efficiently. Also, the chopping knives can wipe the ingredients sticking to the inner surface.

In the above descriptions, a hand blender 10 is used as an example to explain this invention. However, it can be easily envisaged that this invention can also be used in other appliances, like blenders, food processors, juicers, etc, as long as they have driving systems to rotate the chopping elements. In some embodiments, the appliances can even work without a power unit, like a motor. A manual driving system can also be used, and should be considered to fall within the scope of this invention.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A chopping unit for chopping food ingredients, comprising:
a chopping space having a side wall for containing the food ingredients to be chopped, said side wall having an inner surface facing the chopping space;
a chopping element comprising at least one rotatable chopping knife, the chopping knife having a knife tip at its distal end;
a chopping accessory is arranged to cooperate with the rotatable chopping elements for chopping food ingredients in the chopping space during operation; and
wherein the inner surface of the side wall of the chopping space comprises at least one groove adapted to accommodate the knife tip during operation.

2. A chopping unit as claimed in claim 1, wherein the diameter of the outer circumference formed by the rotation of the knife tip is larger than the diameter of the inner surface of the side wall.

3. A chopping unit as claimed in claim 1, wherein the inner surface comprises at least two guidance rims, which are arranged to form therebetween the groove adapted to accommodate the knife tip during operation.

4. A chopping unit as claimed in claim 1, wherein the chopping space comprises an opening end and the inner surface of the side wall comprises a channel which enables communication between the groove and the opening end of the chopping space.

5. A chopping unit as claimed in claim 4, wherein the channel is perpendicular to the groove.

6. A chopping unit as claimed in claim 1, wherein the chopping space further comprises a bottom wall, the side wall and the bottom wall forming a container for receiving the chopped ingredients.

7. A chopping unit as claimed in claim 1, wherein a container with an opening at the top is arranged for receiving the chopped ingredients, during operation, the chopping accessory being arranged on the container and attachable to the opening.

8. A chopping unit as claimed in claim 7, further comprising an outer surface facing away from the chopping space, wherein the outer surface comprises at least one rib.

9. A chopping unit as claimed in claim 7, wherein it further comprises a contoured rim at one end and the container comprises a corresponding contoured rim, and when the chopping accessory is attached to the container, the contoured rims are arranged to cooperate with each other to hold the chopping accessory to the container such that the chopping accessory and the container are prevented from rotating with respect to each other during operation.

10. A chopping unit as claimed in claim 7, wherein it further comprises a chopping protection sieve.

11. A chopping unit as claimed in claim 1, wherein the chopping accessory forms at least a part of the side wall of the chopping space, and the at least one groove is arranged on the chopping accessory.

12. A domestic appliance for processing food, comprising:
a chopping unit according to claim 11; and
a driving system to drive the chopping element to rotate during operation.

13. A domestic appliance as claimed in claim 12, wherein the appliance comprises one of:
a bar blender;
a mixer;
a chopper;
a food processor;
a grinder;
a juicer.
